(19) United States
(12) Patent Application Publication
(10) Pub. No.: US 2008/0084645 A1
(43) Pub. Date: Apr. 10, 2008

(54) EMERGENCY SOLAR POWER SUPPLY

(76) Inventor: NEMER AHMAD JR., Miami, FL (US)

Correspondence Address: LUCA D'OTTONE, 2050 CORAL WAY #503, MIAMI, FL, 33145, US

(21) Appl. No.: 11/780,495

(22) Filed: Jul. 20, 2007

Related U.S. Application Data
(60) Provisional application No. 60/849,214, filed on Oct. 4, 2006.

(51) Int. Cl. H02H 5/04

(52) U.S. Cl. 361/103

(57) ABSTRACT

The object of this application is a solar power supply designed to furnish sinusoidal varying alternating current to a load under normal and emergency conditions. The machine performs at least four different operations including DC to AC power inverting, automatic transfer switching between inverter and incoming AC power, automatic three stage battery charging, battery bank charging. The machine is equipped with solar panels and a power charger that make it usable for extended periods of time both during normal and emergency operations.

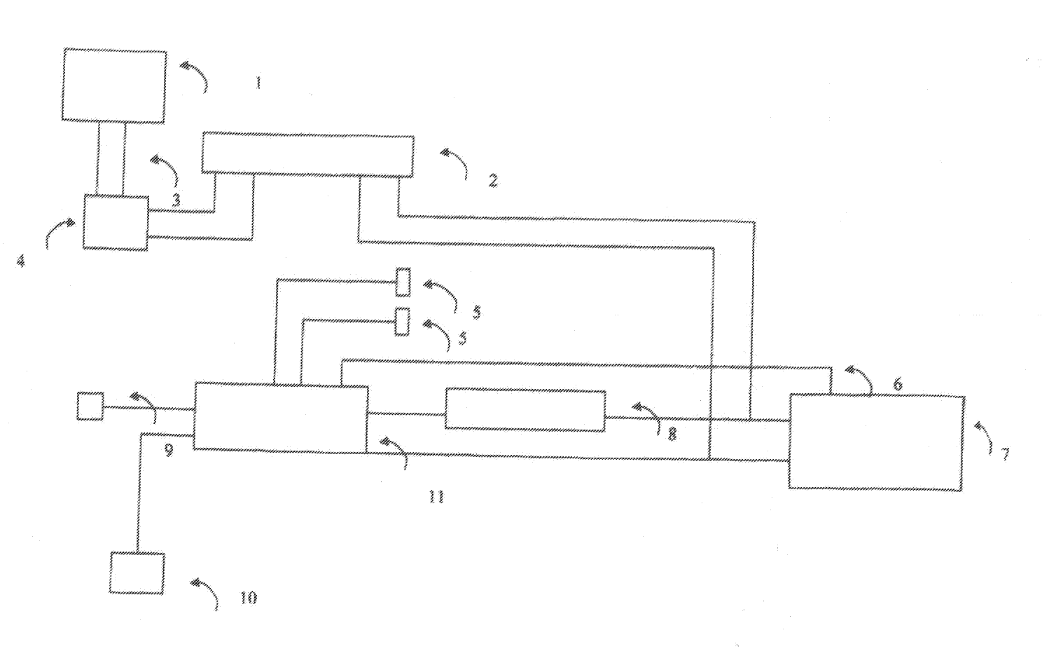

### CROSS REFERENCE TO RELATED APPLICATIONS

This application claims the benefit of U.S. provisional Application No. 60/849,214, filed on Oct. 4, 2006.

### STATEMENT REGARDING FEDERALLY SPONSORED RESEARCH OR DEVELOPMENT

NA

### REFERENCE TO A SEQUENCE LISTING

NA

### BACKGROUND OF THE INVENTION

This invention relates to the field of power sources which are automatically activated when ordinary utility power supplies fail, as during blackouts. More particularly, the invention relates to the field of emergency power supplies of the type containing a storage battery which is charged during normal situations and discharged as an emergency supply during power outages. The invention finds its uniqueness because of the ability to re charge the battery bank from solar energy conversion via solar panels and or a standard 110 volt electrical outlet, and to deliver a substantial amount of alternating current during emergency conditions for a prolonged period of time.

All such systems have certain elements in common due to the fact that today's utility power is invariably alternating current (hereinafter AC) while there has been no such thing as an AC battery invented as yet. All batteries are direct current (DC). During charging conditions the battery bank is charged either by solar power or by regular electric power. Typically solar power is sufficient to re-charge the battery bank, but in case sunlight or any other source of radiant energy is not available, the battery bank can be charged by a regular AC connection. The ability of the system to function in the re-charge mode is particularly important to supply power for prolonged periods of time in emergency situations like the ones created after a hurricane. In order for the battery to supply the usual emergency equipment, which is commonly also AC, an inverter must be in place to convert the DC provided by the battery back to AC. This requirement is obviated, of course, if the load to be powered is itself DC; in such cases of course no inverter is required to convert the DC supplied by the battery to AC. Also the inverter and the battery bank are by passed during normal operation when the machine is placed in between an AC power input and a power output.

A related area of prior art involves so-called UPS (uninterrupted power supply) systems. These systems are used as a buffer between utility power and critical components such as modern digital computers. A UPS has two main functions: first, it prevents potential damage to the computer due to power surge, second it ensures a continuous DC current. The present application, however, is not necessarily concerned with such an uninterruptible power supply because the range of power to be supplied is sufficient to run an entire house for a few days without the need of external AC. However, it is designed to be a far more efficient and practical emergency power supply than those found in the prior art and for this reason has a range of utility not covered by any prior art devices.

### OBJECT OF THE INVENTION

It is therefore an object of the invention to provide an improved portable emergency power supply that can operate for a prolonged period of time without AC due to the ability to re charge the battery bank via a solar panel, vehicle, gas generator, utility power and to supply electrical power without any discharge of harmful emission or noise. It is a further object of the invention to provide an emergency power supply, mobile and much more efficient and less expensive than those in the prior art. It is still another object of this invention to provide an emergency power supply which can be manufactured quickly and inexpensively and yet which provides performances better than those found in the prior art.

### SUMMARY OF THE INVENTION

The present invention satisfies the above listed needs of the art and objects of the invention by its provision of a circuit comprising an inverter providing AC current from a DC battery supply, transfer-switched into a circuit with the load when utility power is lost and being normally connected in series with a filtering choke and the load, and controlled such that the battery is only charged when necessary and a fixed phase difference is introduced between the utility supply voltage and the voltage at the inverter.

### BRIEF DESCRIPTION OF THE DRAWINGS

1) solar panel
2) solar controller
3) electrical connection
4) relay
5) A/C outlets 1 & 2
6) Temperature Sensitive Charger
7) battery bank
8) fuse
9) electrical plug for the connection with an outside A/C supply
10) remote control
11) inverter

### DETAILED DESCRIPTION OF THE INVENTION

The claimed power supply system is a portable electrical device that operates as a self-contained backup power system with a sealed recombinant technology that stores energy in absorbed glass math cells constituting the battery bank combined with an inverter that converts DC voltage to AC voltage automatically via a transfer switch or at a touch of a button. The device provides 120 volt AC power from auxiliary DC batteries, automatic battery charging and automatic AC transfer switching between an external AC source and inverter mode. The unit performs four distinct functions: DC to AC power inverting; automatic transfer switching between inverter power and incoming AC power; automatic three-stage battery charging and solar UV conversion and storage into form of chemical energy stored in the batteries. The device is designed to deliver surge current for starting loads larger than the continuous rating up to about the 7500 watt inverter.

The device is enclosed in a stainless steel mobile cabinet with one shelf and lockable hinged doors. The absorbed glass mat batteries are secured inside the lower half of the cabinet. The Inverter/Charger is mounted horizontally on top of the shelf. The positive (red) and negative (black) cables from the inverter/charger terminal posts are connected to the auxiliary battery. The 12 volt batteries are connected in parallel with 2 or 4 battery cables which are connected to the positive (+) and negative (−) terminals on the Inverter/Charger. High current will pass through the DC wiring. A 300 amp, Listed DC rated slow blow fuse assembly is installed within 18 inches of the positive battery terminal, between the battery and the positive terminal on the Inverter/Charger.

A temperature charging sensor is connected from the ring terminal end of the positive battery terminal. The plug end of the cable is routed through the shelf and connected to the Temperature Sensor Charging (TSC) jack on the front side of the Inverter/Charger; this allows the charge voltage to be controlled based on battery temperature. Also, the electronic circuits protect the inverter from overloads and short circuits. Other protection includes a low and high battery voltage cutoff and automatic shutdown if an over temperature condition occurs.

The Inverter/Charger has one (120 volt) Input and two 20 amps (120 volt) hospital grade receptacles (Outputs). Both outputs are protected by the supplemental circuit breaker when operating in “Invert Mode.” During transfer/charge operation, the outputs are protected by the circuit breakers feeding the two inputs to the unit; each input and output contains three wires: White/neutral; Black/hot; Green/ground. Two 20 amp, four-plex hospital grade receptacle are connected to Output 1 and Output 2 via a 10/3 cable. The receptacles are flush mounted on the outer side of the cabinet and the cable connections are concealed when routed through a conduit. The output is a modified sine wave and is compatible with most electronics, tools and other 120 VAC equipment.

A 20 amp, 120 volt straight blade plug is attached to Input 1 via an 2.5 meters. A connection cable that enters the mobile cabinet and then connects to the white/green/black wires on the Inverter/Charger. Conventional 1.9 cm metal conduit fittings are installed in the knockout holes. The AC input wires are fed through the knockout and into the AC wiring compartment. 15.25 cm are allowed of insulated black, white and green wire to work with. The wires are connected to a compression terminal block: Black to Black, White to White, and Green to Green.

A Remote Control Panel is flush mounted on the superior surface of the mobile cabinet and is connected to the Inverter/Charger via a communications cable that enters the jack on the anterior side of the Inverter/Charger.

The 120 volt AC power enters the device via the 20 amp straight blade plug and enters the Inverter/Charger through Input 1. The Inverter/Charger can automatically sense the incoming AC power and automatically initiate three stage charging: Bulk charging, Acceptance charging and Float charging. When AC is applied to the AC input of the unit, the charger automatically turns ON. When external AC power is available and the INVERT switch is ON (either through the auxiliary switch or the INVERT button on the remote), the inverter will automatically turn ON. When AC is available, the unit will automatically default to charge mode without the operator setting the unit in CHARGE mode. It is necessary to press the CHARGE switch OFF, if you do not want to charge.

The INVERT push-button switch is located on the remote control panel on the superior surface of the device. To turn the inverter ON, press and hold the INVERT switch until the invert LED is solid green. The unit will begin inverting. Press the INVERT switch again to turn the device OFF.

The internal transfer switch allows the device to be connected to an external AC source and transfer the source power through the unit directly to the loads. When the external AC power source is disconnected, the transfer switch allows automatic switching of the loads back to the inverter. When in inverter mode, if the battery voltage drops to 10.0 volts, the device will automatically shut off. Charge the batteries to 13.5 volts to automatically resume operation. Voltage shutdown also occurs for a high battery condition at 15.5 volts. Operation will resume automatically when the battery voltage drops below 15.5 volts.

I claim:

1. A solar power supply comprising:
a battery bank;
inverter means for conversion of alternating current utility power of a first comparatively low frequency to direct battery charging current under normal conditions, and for inversion of direct to alternating current under emergency conditions;
a solar panel means for direct battery charging under both normal and emergency conditions;
a switch for transferring the source of power delivered to output electrical receptacles from input electrical receptacle to inverter connections upon detection of emergency conditions;
a control circuitry;
two electrical output receptacles, said inverter being electrically connected to said electrical output receptacles to supply alternating current to said electrical output receptacles;
an electrical input receptacle, said battery bank being electrically connected to said electrical input receptacle to recharge said battery bank during normal conditions;
an electric by pass circuitry, said electric bypass circuitry connecting said electrical input receptacle to said electrical output receptacles under normal conditions, wherein battery charging is accomplished by switched operation of said inverter and said solar panel, to provide direct current to said battery bank;
a power surge protection device; and
a temperature sensor, means to detect the temperature of the positive terminal of the battery bank

2. A solar power supply, comprising:
a glass math battery bank;
switch means for transferring a load connection from utility terminals to said battery upon detection of failure of the utility;
a solar panel means for direct battery charging under both normal and emergency conditions;
a switch for transferring the source of power delivered to load terminals from input terminals to inverter connections upon detection of emergency conditions;
a power surge protection device; and
a temperature sensor, means to detect the temperature of the positive terminal of the battery bank.
wherein battery charging is accomplished by switched operation of said inverter and said solar panel, to provide direct current to said battery bank.
a power circuit comprising filter means, transformer means, and an inverter means, and
a control circuit comprising an isolation transformer, a phase shifting circuit and a wave shaping circuit. Said control circuit being remotely operated.

3. A solar power supply according to claim 1 or 2 wherein the control circuit provides pulse width modulation to the power delivered to a load under emergency conditions.

4. An emergency power supply according to claim 3 where the carrier frequency of said pulse width modulation means under battery charging conditions is different than during emergency conditions.

5. An emergency power supply according to either of claims 1 or 2 wherein said battery is charged only when the control circuitry detects that its charge is below a predetermined lower limit, whereby said inverter is run only during battery charging and emergency power conditions.
